(19) United States
(12) Patent Application Publication
(10) Pub. No.: US 2003/0018473 A1
(43) Pub. Date: Jan. 23, 2003

(54) SPEECH SYNTHESIZER AND TELEPHONE SET

(76) Inventors: HIROKI OHNISHI, OSAKA (JP); MAKOTO HASHIMOTO, KYOTO (JP)

Correspondence Address: BEVERIDGE DEGRANDI WEILACHER & YOUNG LLP, 1850 M STREET N W, SUITE 800, WASHINGTON, DC, 20036

(21) Appl. No.: 09/323,243

(22) Filed: Jun. 1, 1999

(30) Foreign Application Priority Data
Jun. 2, 1998 (JP) 152885/1998
May 18, 1998 (JP) 137409/1999

(51) Int. Cl. G10L 13/00

(52) U.S. Cl. 704/258

(57) ABSTRACT

A speech synthesizer comprises means for automatically setting an initial accent type as an accent type corresponding to character information entered by character information entry means, and producing and outputting synthetic speech corresponding to the character information in accordance with the set initial accent type, first entry means for causing a user to enter an instruction to change the accent type, and means for automatically changing the accent type every time the instruction to change the accent type is entered, and producing and outputting synthetic speech corresponding to the character information in accordance with the changed accent type.

### BACKGROUND OF THE INVENTION

1. Field of the Invention

The present invention relates to a speech synthesizer and a telephone set for converting character information into speech.

2. Description of the Prior Art

Accent types in the Japanese language will be first described. In the following description, “mora” means the relative length of a sound to be a unit of stress and intonation in the prosody theory. Generally, one mora corresponds to the length of one syllable including a short vowel. An accent in the Japanese language is represented by the fundamental frequency of the mora.

In the Japanese language, the following accent rule holds with respect to the fundamental frequency.

(1) The first mora and the second mora in one word differ in the fundamental frequency.

(2) The fundamental frequency is decreased at one point in one word.

(3) The accent type is determined depending on the position where the fundamental frequency is decreased.

When a name “ [symbol] ” (“Oonisi” in the Roman alphabet) composed of four moras is taken as an example, five accent types hold, as shown in FIGS. 6a to 6e.

FIG. 6a shows the 0-th type. In the 0-th type, the fundamental frequency of the first mora is low, and the fundamental frequencies of the second mora and the subsequent moras are high.

FIG. 6b shows the 1-th type. In the 1-th type, the fundamental frequency of the first mora is high, and the fundamental frequencies of the second mora and the subsequent moras are low. That is, the fundamental frequency is decreased subsequently to the first mora.

FIG. 6c shows the 2-th type. In the 2-th type, the fundamental frequency of the first mora is low, the fundamental frequency of the second mora is high, and the fundamental frequencies of the third mora and the subsequent moras are low. That is, the fundamental frequency is decreased subsequently to the second mora. FIG. 6d shows the 3-th type. In the 3-th type, the fundamental frequency of the first mora is low, the fundamental frequencies of the second and third moras are high, and the fundamental frequencies of the fourth mora and the subsequent moras are low. That is, the fundamental frequency is decreased subsequently to the third mora.

FIG. 6e shows the 4-th type. In the 4-th type, the fundamental frequency of the first mora is low, the fundamental frequencies of the second, third and fourth moras are high, and the fundamental frequencies of the fifth mora and the subsequent moras are low. That is, the fundamental frequency is decreased subsequently to the fourth mora.

In the case of a word composed of n moras, there exist (n+1) accent types from the 0-th type to the n-th type.

In a text speech synthesizer for converting character information into speech, when a user provides accent information to entered character information, an accent mark is placed on the position where the fundamental frequency of the entered character information is decreased (an accent position).

Consider a case where a name “ [symbol] ” (“Nisida” in the Roman alphabet) is speech-synthesized, for example. In this case, if the accent type is the 1-th type, “ [symbol] ” (“ni*sida” in the Roman alphabet) is entered into the speech synthesizer when the accent mark is taken as “*”. A speech synthesis instruction is entered into the speech synthesizer, to output speech having a fundamental frequency corresponding to the accent type set by the user from the speech synthesizer. The user confirms whether or not the accent type set by himself or herself is suitable on the basis of the outputted speech.

When the user judges that the accent type set by himself or herself is unsuitable, the accent type is changed. If the accent type is changed into the 2-th type, for example, “z,6 ” (“nisi*da”0 in the Roman alphabet) is entered again.

In such a conventional speech synthesizer, operations performed until a suitable accent type is determined are troublesome.

### SUMMARY OF THE INVENTION

An object of the present invention is to provide a speech synthesizer in which operations performed until a suitable accent type is determined are simplified.

Another object of the present invention is to provide a telephone set in which operations performed until a suitable accent type is registered are simplified when a name and an accent type are registered in relation to a telephone number.

A speech synthesizer according to the present invention is characterized by comprising character information entry means for entering character information, means for automatically setting an initial accent type as an accent type corresponding to the character information entered by the character information entry means and producing and outputting synthetic speech corresponding to the character information in accordance with the set initial accent type, first entry means for causing a user to enter an instruction to change the accent type, second entry means for causing the user to enter an instruction to determine the accent type, means for automatically changing the accent type every time the instruction to change the accent type is entered, and producing and outputting synthetic speech corresponding to the character information in accordance with the changed accent type, and means for registering the currently set accent type in storage means as an accent type suitable for the character information when the instruction to determine the accent type is entered.

An example of the first entry means is one for issuing the instruction to change the accent type when a predetermined first key is pressed, and an example of the second entry means is one for issuing the instruction to determine the accent type when a second key different from the first key is pressed.

An example of the first entry means is one for issuing the instruction to change the accent type when a predetermined key is pressed only for a time period shorter than a predetermined time period, and an example of the second entry means is one for issuing the instruction to determine the accent type when the predetermined key is pressed continuously for not less than the predetermined time period.

An example of the first entry means is one comprising a plurality of numeric keys to which different accent types are previously assigned, and issuing, when the arbitrary numeric key out of the numeric keys is pressed, an instruction to change the accent type into an accent type corresponding to the numeric key.

An example of the initial accent type is a particular accent type previously determined irrespective of the character information entered by the character information entry means.

An example of the initial accent type is an accent type determined depending on the number of moras composing the character information entered by the character information entry means.

An example of the initial accent type is an accent type determined depending on positions of vowels included in the character information entered by the character information entry means.

In a telephone set comprising a database for registering for each telephone number a name and accent type information relating to the name, and means for retrieving from a registering database a name and accent information corresponding to the telephone number of a person who has called and producing and outputting, when the name and the accent information corresponding to the telephone number of the person who has called exist in the database, synthetic speech corresponding to the name of the person who has called on the basis of the name and the accent information corresponding to the name of the person who has called, a telephone set according to the present invention is characterized by comprising number information entry means for entering telephone number information, name information entry means for entering name information corresponding to the telephone number information entered by the telephone number entry means, means for automatically setting an initial accent type as an accent type corresponding to the name information entered by the name information entry means, and producing and outputting synthetic speech corresponding to the name information in accordance with the set initial accent type, first entry means for causing a user to enter an instruction to change the accent type, second entry means for causing the user to enter an instruction to determine the accent type, means for automatically changing the accent type every time the instruction to change the accent type is entered, and producing and outputting synthetic speech corresponding to the name information in accordance with the changed accent type, and means for registering, when the instruction to determine the accent type is entered, the currently set accent type in a registering database as an accent type suitable for the name information in relation to the number information and the name information which are entered.

An example of the first entry means is one for issuing the instruction to change the accent type when a predetermined first key is pressed, and an example of the second entry means is one for issuing the instruction to determine the accent type when a second key different from the first key is pressed.

An example of the first entry means is one for issuing the instruction to change the accent type when a predetermined key is pressed only for a time period shorter than a predetermined time period, and an example of the second entry means is one for issuing the instruction to determine the accent type when the predetermined key is pressed continuously for not less than the predetermined time period.

An example of the first entry means is one comprising a plurality of numeric keys to which different accent types are previously assigned, and issuing, when the arbitrary numeric key out of the numeric keys is pressed, an instruction to change the accent type into an accent type corresponding to the numeric key.

An example of the initial accent type is a particular accent type previously set irrespective of the character information entered by the character information entry means.

An example of the initial accent type is an accent type determined depending on the number of moras composing the character information entered by the character information entry means.

An example of the initial accent type is an accent type determined depending on positions of vowels included in the character information entered by the character information entry means.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram showing the schematic configuration of a number display correspondence telephone set;

FIG. 2 is a schematic view showing a part of the contents of a registering database 5;

FIG. 3 is a schematic view showing how speech elements corresponding to phonemes “o”, “o”, “ni” and “si” selected from a speech database 8 are connected;

FIG. 4 is a flow chart showing the procedure for registration processing for registering telephone number information, name information and accent type information in the registering dababase 5;

FIG. 5 is a schematic view showing a modified example of data registered in the registering database 5; and

FIGS. 6a-6e are schematic views for explaining accent types in the Japanese language.

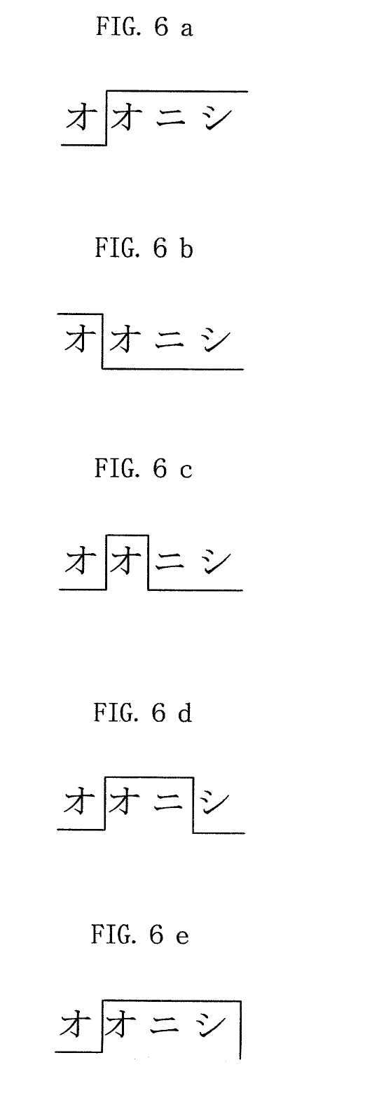

### DETAILED DESCRIPTION OF THE PREFERRED EMBODIMENTS

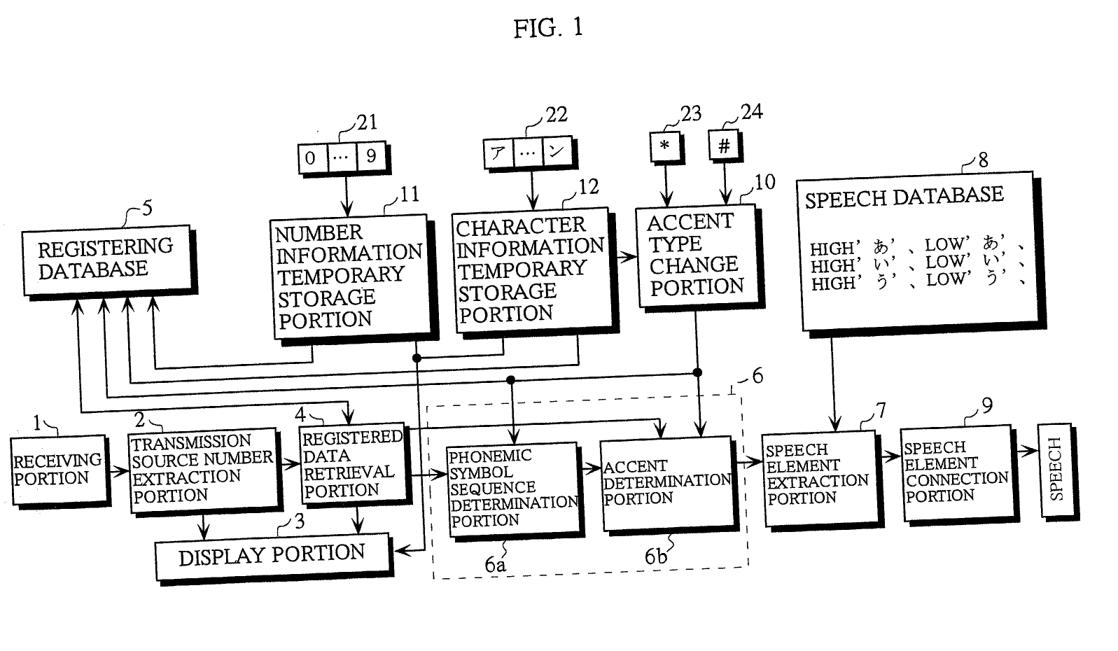

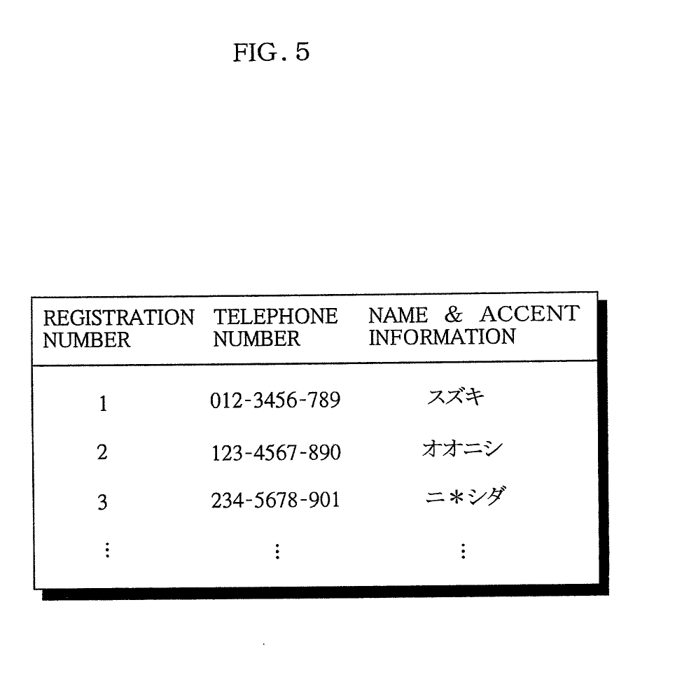

Referring now to FIGS. 1 to 5, description is made of an embodiment in a case where the present information is applied to a number display correspondence telephone set.

The number display correspondence telephone set is a telephone set capable of displaying the telephone number of a person who has called on its display portion.

FIG. 1 illustrates the configuration of a number display correspondence telephone set having the function of speech-outputting the name of a person who has called by speech synthesis in addition to the function of displaying the telephone number of the person who has called on its display portion.

In FIG. 1, a receiving portion 1 is connected to a public telephone line, to acquire telephone number information and speech information which have been received. The speech information is reproduced and outputted, as in a normal telephone set.

A transmission source number extraction portion 2 extracts telephone number information of a source of transmission out of the information received in the receiving portion 1. The telephone number information extracted in the transmission source number extraction portion 2 is displayed on the display portion 3.

A registered data retrieval portion 4 searches a registering database 5, to acquire name information and accent type information corresponding to the telephone number information sent from the transmission source number extraction portion 2. The registered data retrieval portion 4 sends the acquired name information to the display portion 3 , and sends the same to a phonemic symbol sequence determination portion 6a in a character information analysis portion 6. In the display portion 3, the name information sent from the registered data retrieval portion 4 is displayed. The registered data retrieval portion 4 sends the acquired accent type information to an accent determination portion 6b in the character information analysis portion 6.

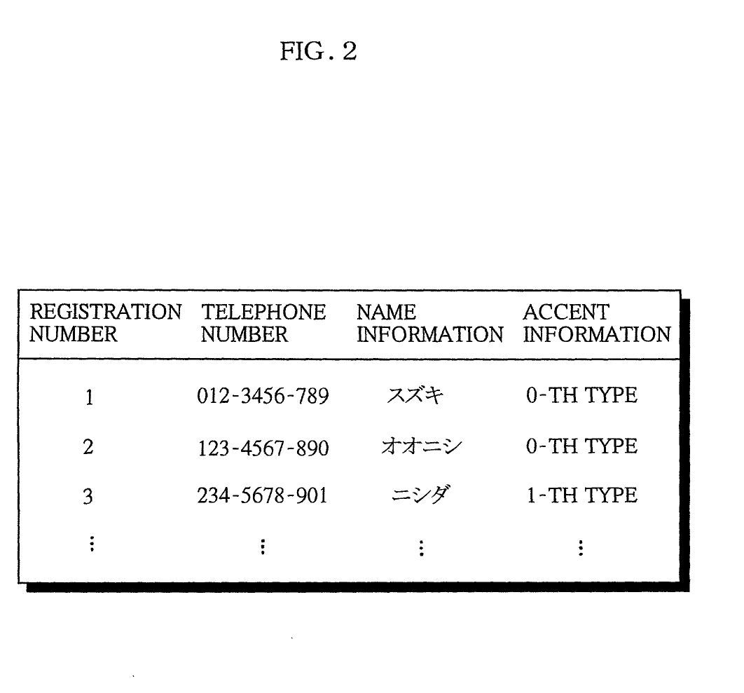

In the registering database 5, the telephone number information, the name information and the accent type information which are previously registered by a user are stored for each registration number, as shown in FIG. 2. The details of processing for registering the telephone number information, the name information and the accent type information will be described later.

The phonemic symbol sequence determination portion 6a in the character information analysis portion 6 determines a phonemic symbol sequence corresponding to character information sent from the registered data retrieval portion 4. When the character information is “ [symbol] ” (“oonisi” in the Roman alphabet), for example, a phonemic symbol sequence “oonisi” is produced.

The accent determination portion 6b determines a fundamental frequency for each of phonemic symbols composing the phonemic symbol sequence determined by the phonemic symbol sequence determination portion 6a on the basis of the accent type information sent from the registered data retrieval portion 4. That is, the accent determination portion 6b determines whether the fundamental frequency is high or low for each of the phonemic symbols composing the phonemic symbol sequence determined by the phonemic symbol sequence determination portion 6a.

A speech element having a high fundamental frequency and a speech element having a low fundamental frequency are registered for each of various types of phonemes in a speech database 8. The speech element means a waveform element used for speech synthesis.

A speech element extraction portion 7 extracts from the speech database 8 a speech element corresponding to each of the phonemic symbols composing the phonemic symbol sequence determined by the phonemic symbol sequence determination portion 6. In this case, judgment which of the speech element having a high fundamental frequency and the speech element having a low fundamental frequency out of the two types of speech elements corresponding to the phonemic symbols should be extracted conforms to the fundamental frequency determined by the accent determination portion 6b.

A speech element connection portion 9 connects the speech elements extracted by the speech element extraction portion 7 and connects a speech waveform obtained by the connection and a speech waveform composing a previously determined fixed message, to produce and output synthetic speech.

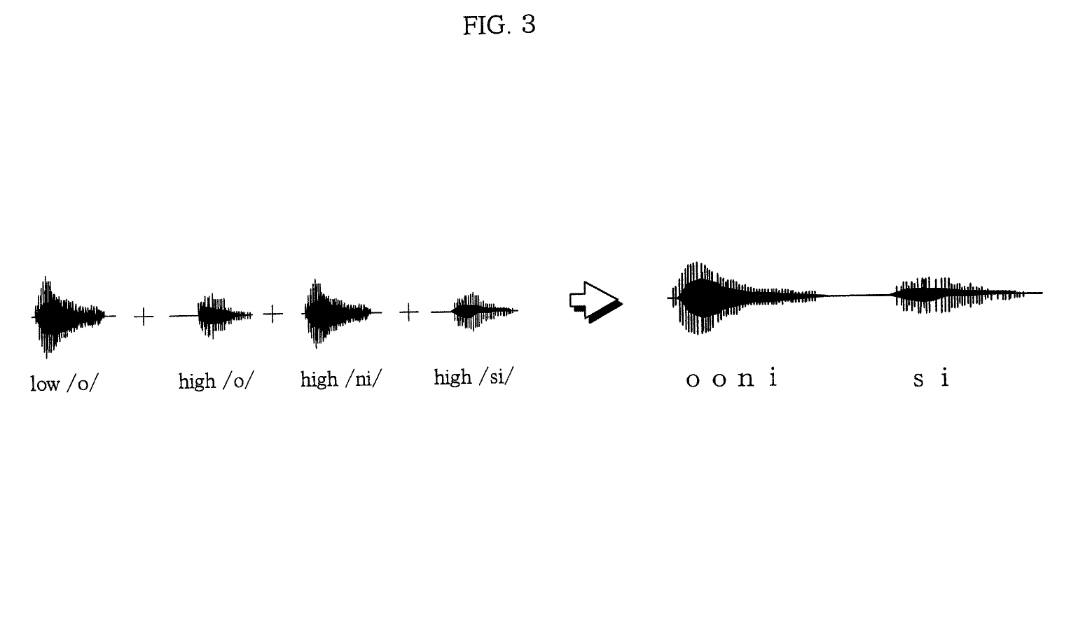

When the speech elements extracted by the speech element extraction portion 7 are speech elements respectively corresponding to “o” having a low fundamental frequency, “o” having a high fundamental frequency, “ni” having a high fundamental frequency and “si” having a high fundamental frequency, as shown in FIG. 3, the speech element connection portion 9 connects the speech elements and connects a speech waveform obtained by the connection and a speech waveform composing a previously determined fixed message (for example, “ [symbol] ” which means “this is a call from Mr. . . . ” in English), to output synthetic speech “ [symbol] ” (which means “this is a call from Mr. Oonisi” in English).

Description is now made of processing for registering telephone number information, name information, and accent type information.

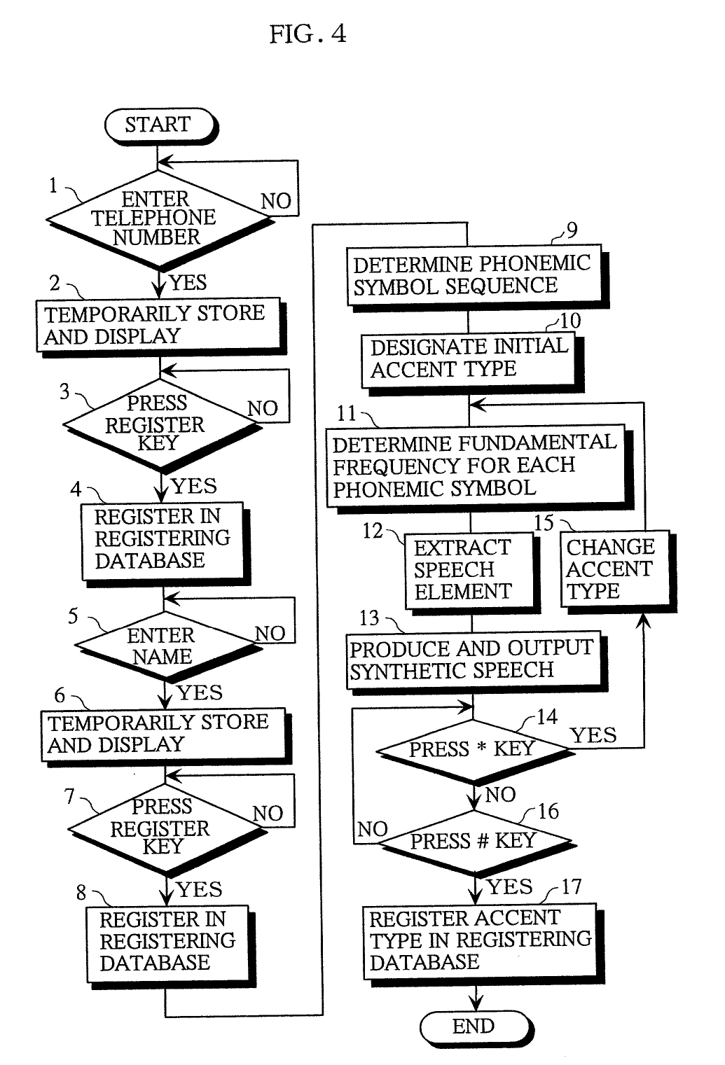

FIG. 4 shows the procedure for the processing for registering the telephone number information, the name information and the accent type information.

When a user enters the telephone number of a particular person which will be registered using a key 21 for entering a telephone number (step 1), the entered telephone number is temporarily stored in a number information temporary storage portion 11, and the entered telephone number is displayed on the display portion 3 (step 2). When a register key (not shown) is pressed (step 3), the telephone number stored in the number information temporary storage portion 11 is stored in the registering database 5 (step 4).

When the user enters the name of the particular person which will be registered using a key 22 for entering a name (step 5), the entered name is temporarily stored in a character information temporary storage portion 12, and the entered name is displayed on the display portion 3 (step 6). When the register key (not shown) is pressed (step 7), the name stored in the character information temporary storage portion 12 is stored in the registering database 5 (step 8).

Thereafter, the phonemic symbol sequence determination portion 6a determines a phonemic symbol sequence corresponding to the name stored in the character information temporary storage portion 12 (step 9).

An accent type change portion 10 stores, on the basis of the number of moras composing the name stored in the character information temporary storage portion 12, all accent types which can be presumed with respect to the name, and sends the initial accent type to the accent determination portion 6b (step 10).

Specifically, the accent type change portion 10 stores, when the number of moras composing the name stored in the character information temporary storage portion 12 is n, the accent types from the 0-th type to the n-th type, and designates the initial accent type in the accent determination portion 6b. The initial accent type is set to the 0-th type, for example. Accent types statistically suitable for the number of moras composing the name may be previously found, and an accent type statistically suitable for the number of moras composing an entered name may be taken as the initial accent type.

The accent determination portion 6b determines a fundamental frequency for each of phonemic symbols in the phonemic symbol sequence determined by the phonemic symbol sequence determination portion 6a on the basis of the accent type designated by the accent type change portion 10 (step 11). That is, it determines whether the fundamental frequency is high or low for each of the phonemic symbols in the phonemic symbol sequence determined by the phonemic symbol sequence determination portion 6a.

The speech element extraction portion 7 extracts from the speech database 8 a speech element corresponding to each of the phonemic symbols composing the phonemic symbol sequence determined by the phonemic symbol sequence determination portion 6a in consideration of the fundamental frequency of the phonemic symbol determined by the accent determination portion 6b (step 12).

The speech element connection portion 9 connects the speech elements extracted by the speech element extraction portion 7, to produce and output synthetic speech (step 13).

The user judges whether or not the currently selected accent type is suitable on the basis of the synthetic speech outputted at the step 13, to press a key used for determining the currently selected accent type (for example, a # key) 24 when it is judged that it is suitable, while pressing a key used for changing an accent type (for example, a * key) 23 when it is judged that it is not suitable.

When the * key 23 used for changing the accent type is pressed (YES at step 14), the accent type change portion 10 selects an accent type subsequent to the currently selected accent type out of a plurality of accent types currently stored, and indicates the selected accent type to the accent determination portion 6b (step 15). That is, the accent type change portion 10 cyclically changes the accent type into the 0-th accent type, the 1-th accent type, the 2-th accent type, . . . , the n-th accent type in this order when the key 23 is pressed.

When the accent type is indicated to the accent determination portion 6b, the same operations as those at the steps 11, 12, and 13 are performed, so that synthetic speech corresponding to the accent type indicated to the accent determination portion 6b is produced and outputted.

When the # key 24 used for determining the currently selected accent type is pressed at the step subsequent to the step 13 (YES at step 16), the accent type currently selected by the accent type change portion 10 is registered in the registering database 5 (step 17). Consequently, telephone number information, name information and accent type information are registered in the registering database 5.

In the above-mentioned embodiment, the * key 23 is used in order to change the accent type, while the # key is used in order to determine the accent type. However, it is also possible to change and determine the accent type using a single key. For example, the accent type may be changed when the * key 23 is pressed for a time period shorter than a predetermined time period, while being determined when the * key 23 is pressed for not less than the predetermined time period.

Although in the above-mentioned embodiment, the name information and the accent type information are registered as separate items in the registering database 5. However, it is also possible to include the accent type information in the name information by inserting, into the position where the fundamental frequency is decreased in the name information, a symbol (for example, *) indicating that the fundamental frequency is decreased.

A company name may be used in place of the name to be registered in the registering database 5. Further, character information such as a name may be entered by not key entry but speech entry.

Although in the above-mentioned embodiment, the speech element having a high fundamental frequency and the speech element having a low fundamental frequency are registered for each of various types of phonemes in the speech database 8, only the speech element having a low fundamental frequency may be registered for each of various types of phonemes in the speech database 8. In this case, the speech element extraction portion 7 extracts, with respect to each of phonemes composing a phonemic symbol sequence corresponding to a name, a corresponding speech element (a speech element having a low fundamental frequency). From the speech element extracted in correspondence with the phoneme whose fundamental frequency is determined to be high by the accent type, a speech element having a shorter pitch is produced. Thereafter, the speech elements are connected.

Only the speech element having a high fundamental frequency may be registered for each of various types of phonemes in the speech database 8. In this case, the speech element extraction portion 7 extracts, with respect to each of the phonemes composing the phonemic symbol sequence corresponding to the name, a corresponding speech element. From the speech element extracted in correspondence with the phoneme whose fundamental frequency is determined to be low by the accent type, a speech element having a longer pitch is produced. Thereafter, the speech elements are connected.

Description is now made of a case where an English name is registered.

Although an accent is represented by the sound pitch in the case of the Japanese language, while being represented by the sound intensity in the English language. That is, in the English language, an accent mark is placed on a position which is strongly pronounced in a phonetic symbol of an English word.

Consequently, an accent type is determined depending on a change position from a sound having a high fundamental frequency to a sound having a low fundamental frequency in the Japanese language, while being determined depending on how many vowels are there before a vowel strongly pronounced in the English language.

Although the Japanese language and the English language differ in a rule for determining an accent type, it is possible to use, as a method of determining an accent type suitable for an English name, the same method as the above-mentioned method of determining an accent type suitable for a Japanese name.

That is, synthetic speech corresponding to an initial accent type is first outputted with respect to the English name entered by the user. For example, a type in which a vowel strongly pronounced is the first vowel is taken as the initial accent type.

When the user presses a key for changing an accent type (for example, a # key), the accent type is changed. For example, the accent type is changed into a type in which a vowel strongly pronounced is the second vowel. Synthetic speech corresponding to the changed accent type is outputted.

When the user presses a key for determining an accent type (for example, a * key), the currently selected accent type is registered in the registering database.

In the case of the English language, description is made of an operation for producing synthetic speech corresponding to an accent type.

A speech element having a high sound intensity and a speech element having a low sound intensity are previously stored for each of various types of phonemes in the speech database 8. The speech element extraction portion 7 extracts, with respect to each of phonemes composing a phonemic symbol sequence corresponding to an English name, a speech element having a high sound intensity from the speech database 8 with respect to the phoneme strongly pronounced which is determined by the accent type, while extracting a speech element having a low sound intensity from the speech database 8 with respect to the other phonemes. The extracted speech elements are connected.

Alternatively, only a speech element having a standard sound intensity is registered for each of various types of phonemes in the speech database 8. The speech element extraction portion 7 extracts, with respect to each of the phonemes composing the phonemic symbol sequence corresponding to the English name, a corresponding speech element. From the speech element corresponding to the phoneme strongly pronounced which is determined by the accent type, a speech element having a larger amplitude is produced. Thereafter, the extracted speech elements are connected.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A speech synthesizer comprising:
character information entry means for entering character information;
means for automatically setting an initial accent type as an accent type corresponding to the character information entered by the character information entry means, and producing and outputting synthetic speech corresponding to said character information in accordance with the set initial accent type;
first entry means for causing a user to enter an instruction to change the accent type;
second entry means for causing the user to enter an instruction to determine the accent type;
means for automatically changing the accent type every time the instruction to change the accent type is entered, and producing and outputting synthetic speech corresponding to said character information in accordance with the changed accent type; and
means for registering the currently set accent type in storage means as an accent type suitable for said character information when the instruction to determine the accent type is entered.

2. The speech synthesizer according to claim 1, wherein
the first entry means issues the instruction to change the accent type when a predetermined first key is pressed, and
the second entry means issues the instruction to determine the accent type when a second key different from the first key is pressed.

3. The speech synthesizer according to claim 1, wherein
the first entry means issues the instruction to change the accent type when a predetermined key is pressed only for a time period shorter than a predetermined time period, and
the second entry means issues the instruction to determine the accent type when said predetermined key is pressed continuously for not less than the predetermined time period.

4. The speech synthesizer according to claim 1, wherein
the first entry means comprises a plurality of numeric keys to which different accent types are previously assigned, and issues, when the arbitrary numeric key out of the numeric keys is pressed, an instruction to change the accent type into an accent type corresponding to the numeric key.

5. The speech synthesizer according to claim 1, wherein
the initial accent type is a particular accent type previously determined irrespective of the character information entered by the character information entry means.

6. The speech synthesizer according to claim 1 wherein
the initial accent type is an accent type determined depending on the number of moras composing the character information entered by the character information entry means.

7. The speech synthesizer according to claim 1, wherein
the initial accent type is an accent type determined depending on positions of vowels included in the character information entered by the character information entry means.

8. In a telephone set comprising a database for registering for each telephone number a name and accent type information relating to the name, and means for retrieving from a registering database a name and accent information corresponding to the telephone number of a person who has called and producing and outputting, when the name and the accent information corresponding to the telephone number of the person who has called exist in the database, synthetic speech corresponding to the name of the person who has called on the basis of the name and the accent information corresponding to the name of the person who has called, a telephone set comprising: number information entry means for entering telephone number information;
name information entry means for entering name information corresponding to the telephone number information entered by the telephone number entry means;
means for automatically setting an initial accent type as an accent type corresponding to the name information entered by the name information entry means, and producing and outputting synthetic speech corresponding to said name information in accordance with the set initial accent type;
first entry means for causing a user to enter an instruction to change the accent type;
second entry means for causing the user to enter an instruction to determine the accent type;
means for automatically changing the accent type every time the instruction to change the accent type is entered, and producing and outputting synthetic speech corresponding to said name information in accordance with the changed accent type; and
means for registering, when the instruction to determine the accent type is entered, the currently set accent type in a registering database as an accent type suitable for said name information in relation to the number information and the name information which are entered.

9. The telephone set according to claim 8, wherein
the first entry means issues the instruction to change the accent type when a predetermined first key is pressed, and
the second entry means issues the instruction to determine the accent type when a second key different from the first key is pressed.

10. The telephone set according to claim 8, wherein
the first entry means issues the instruction to change the accent type when a predetermined key is pressed only for a time period shorter than a predetermined time period, and
the second entry means issues the instruction to determine the accent type when said predetermined key is pressed continuously for not less than the predetermined time period.

11. The telephone set according to claim 8, wherein
the first entry means comprises a plurality of numeric keys to which different accent types are previously assigned, and issues, when the arbitrary numeric key out of the numeric keys is pressed, an instruction to change the accent type into an accent type corresponding to the numeric key.

12. The telephone set according to claim 8, wherein
the initial accent type is a particular accent type previously set irrespective of the character information entered by the character information entry means.

13. The telephone set according to claim 8, wherein
the initial accent type is an accent type determined depending on the number of moras composing the character information entered by the character information entry means.

14. The telephone set according to claim 8, wherein
the initial accent type is an accent type determined depending on positions of vowels included in the character information entered by the character information entry means.
